(19) United States
(12) Patent Application Publication
(10) Pub. No.: US 2007/0088847 A1
(43) Pub. Date: Apr. 19, 2007

(54) Method and System to Interact with Information Services using Messaging

(75) Inventor: Sreeranga Prasnnakumar Rajan, Santa Clara, CA (US)

Correspondence Address: Sreeranga P. Rajan, 5201 Great America Pkwy., Suite 320, Santa Clara, CA, 95054, US

(73) Assignee: SVAZU INC., Santa Clara, CA (US)

(21) Appl. No.: 11/306,428

(22) Filed: Dec. 28, 2005

Related U.S. Application Data
(60) Provisional application No. 60/639,988, filed on Dec. 30, 2004.

(51) Int. Cl. G06F 15/173

(52) U.S. Cl. 709/238

(57) ABSTRACT

In this invention we provide a method and system to interact with information services using a messaging client on a device. The system of the invention enables the user to invoke services using existing wireless/wired networks using messaging.

### FIELD OF INVENTION

This invention relates to the field of information services. In particular, the invention relates to technologies for enabling access to services and applications from message clients.

### BACKGROUND OF THE INVENTION

As computing technology has evolved, users have been able to access increased amounts of information from an ever-expanding universe of data sources. However, information is distributed among multiple sources and formats, and the method of access to information is limited. The information seeker either has to fill up forms or navigate by clicking HTML links provided by a Web browser. For example, Web services such as directory information can be accessed by filling up a form in the Web page provided by the Web service. But the access to the form is limited to a browser. Such limitations and limitations such as the connectivity with the information source and form in which the information is available from the source pose a significant challenge to access information in real time. Hence an invention of a method of invoking web services using messaging would solve this problem. The availability of various types of communication devices produces a need to have these devices interact with each other in a manner which is cost efficient and which can be easily implemented. Examples of such communications are Instant Messaging on mobile devices and desktop devices. Text messaging such as SMS on GSM networks and text messaging on CDMA networks are used for short message communication. Accordingly, the present invention is directed to a communication system and a method for invoking services using messaging from a device that substantially obviates one or more of the problems due to limitations and disadvantages of the existing technologies.

### SUMMARY OF INVENTION

In this invention we present a method and system to interact with information services using messaging clients from a communicating device. The method comprises of the following steps: Analyze a message which might be text, audio, or video; Separate the text, audio, and video into separate streams; Segment the message into: (1) Action requested; Identify the requestor (i.e. the subject) and provide authentication if necessary; (2) Data or object on which the action has to happen; (3) Data or events to be generated as a result of the action; Provide each segment of the message to the appropriate information service corresponding to the action requested.

### BRIEF DESCRIPTION OF THE DRAWING FIGURES

FIG. 1 provides the architecture of the system and depicts the information flow.

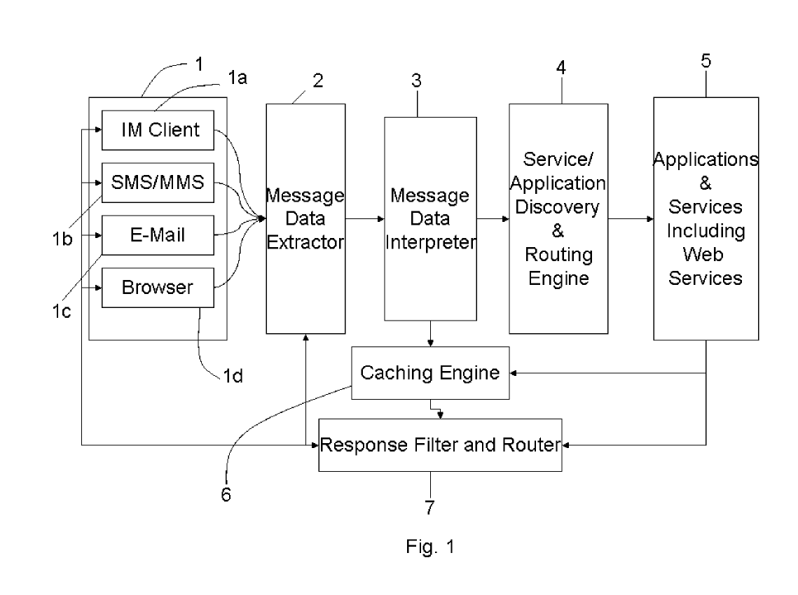

### DESCRIPTION OF THE PREFERRED EMBODIMENTS

A messaging client (1) such as Instant Messenger (1a), SMS/MMS (1b), E-Mail (1c), and Browser (1d) is used by the user to send a query request for information.

This message is sent to the Message Extractor (2) for segmenting the message into control and data parts. The control part holds the header information such as the message identifier, details pertaining to which client, protocol, and user. The data part has the information request sent by the user.

This data segment is sent to the Message Interpreter (3). It first checks with the Caching Engine (6) if this request has been processed earlier. Depending on the nature of the request, whether it needs updating and either it applies natural language conversation to interpret the request or sends back the answer cached earlier to the messaging server. The natural language conversation engine is based on rules to interpret the message. If there is ambiguity, it is sent back to the sender for clarification. If there is no ambiguity, the result of the interpretation is to obtain what the information was requested by the sender.

Depending on the result of the message interpretation, the Application/Service Discovery and Routing Engine (4) then chooses possible applications/services that can answer the query. It routes the query to the appropriately chosen applications/services.

The resulting output of the information services are then input to the Response Filter and Routing Engine (7), which sends the result to the Caching Engine (6) for storing the result obtained for the query and then sends the result back to the appropriate messaging clients (1).

Sample Scenarios

Directory Assistance:

Finding addresses and phone numbers of people or businesses are currently offered as Web services.

Auction

Users can bid, buy, sell their products accessing and communicating auction information from various auction web sites.

Speedwriting E-Mail

With a power message interpreter, users can send a few characters as a part of the word that they would like to send as email. The message interpreter would detect the words, find the corresponding original words and replace them with the full words.

IM gaming

Gaming through phones would be considerably improved through this invention. Games hosted as a service on a server can be interacted using an Instant Messenger (IM).

What is claimed is:

1. A method of invoking a service from a messaging client comprising of:
a. Instant Messenger (IM) or an e-mail client or a Web-based communicating client located on a device;
b. Messaging server, that includes a instant messaging server, e-mail server, web server, and a presence server;
c. Message Extractor that splits a message into a control segment and a data segment, where the control part or the header is used to route the message back to the appropriate client based on the presence server information and the data part contains the information sent by the messaging client;
d. Message Interpreter, which takes the data segment of the message from the message extractor;
e. Learning engine;
f. Application/Service Discovery and Routing Engine;
g. Caching Engine;
h. Response Filter and Router.
